(19) United States
(12) Patent Application Publication
(10) Pub. No.: US 2019/0384362 A1
(43) Pub. Date: Dec. 19, 2019

(54) LAPTOP AND TABLET TWO-IN-ONE COMPUTER

(71) Applicant: Wuhan China Star Optoelectronics Technology Co., Ltd., Wuhan, Hubei (CN)

(72) Inventor: Zhenzhou XING, Wuhan, Hubei (CN)

(21) Appl. No.: 15/571,016

(22) PCT Filed: Oct. 19, 2017
(86) PCT No.: PCT/CN2017/106927

§ 371 Date: Oct. 31, 2017

(30) Foreign Application Priority Data
Jul. 19, 2017 (CN) 201710589159.5

(51) Int. Cl. G06F 1/16; G06F 3/0488

(52) U.S. Cl. CPC G06F 1/1652; G06F 3/04886; G06F 1/1681; G06F 1/1626; G06F 1/1616

(57) ABSTRACT

The present invention provides a laptop and tablet two-in-one computer including a bendable back panel and a flexible touch display panel installed on a bendable back panel. The bendable back panel includes a first back plate portion and a second back plate portion and the second back plate portion, and then the bendable back panel is further in flat state or bent state. The flexible touch display has the keyboard function and the touch panel control function by displaying the keyboard and the touch panel. The invention eliminates the physical keyboard design of the traditional two-in-one computer by integrating the flexible touch display panel with the bendable back panel so that the flexible touch display is achieved with a touch panel, and the invention simplifies the complicated design of the traditional two-in-one computer, and extends the service life and has the advantages of convenient use and superior performance.

### FIELD OF THE DISCLOSURE

The present invention relates to the field of display technology, and more particularly to a laptop and tablet two-in-one computer.

### BACKGROUND

With the development of modern technology, multi-functional electronic products are more and more popular. Taking a computer as an example, the design is inspired from a laptop and tablet two-in-one computer. It combines the advantages of the integration, compactness, and portability. The two-in-one computer is suitable for both entertainment and office. The vast number of consumers recognizes computers have free to transform and flat shape in the office, home, outdoor and other occasions. The replacement trend of traditional notebook computers been formed. With a number of USB interface, mini-HDMI port, SD card slot, the two-in-one product can easy access to a wide range of terminal equipment, whether it is storage or large file sharing. Even if the projector is connected, it is easy to achieve now.

In fact, the performance of the current tablet has been beyond some of the computer, with Windows/Android dual system installation and use. It can almost fully meet the demands for the daily office, games, video viewing, e-mail, Internet, news readings and others. Only when the tablet is used as a tool, it is not possible to compare the computer with the detachable physical keyboard function on the user experience. Therefore, the current two-in-one computer usually adopts a complete physical keyboard with touch-enabled tablet. This detachable notebook structure design is taken into account for the tablet and laptop dual experience.

However, there is the existing split-able two-in-one computer currently, and the connection design is cumbersome, not simple enough, and its function is only a simple combination of both. This cannot achieve the important performance of the laptop, but also reach the convenience of the tablet, and plug-in connection design also shorten the life of the two-in-one computer.

Therefore, it is necessary to propose a new laptop and tablet two-in-one computer design to solve the above technical problems.

### SUMMARY

The object of the present invention is to provide a laptop and tablet two-in-one computer. It eliminates the physical keyboard, solves the problems of the cumbersome traditional two-in-one computer connection design, low life and so on. It has the advantage of the use of convenient, superior performance and so on.

In order to achieve the above object, the present invention provides a laptop and tablet two-in-one computer having a laptop mode and a tablet mode including a bendable back panel and a flexible touch display panel provided on the bendable back panel.

The bendable back panel includes a first back plate portion and a second back plate portion which are connected by a hinge. An angle between the first back plate portion and the second back plate portion of the bendable back panel is changed by the hinge so as to be in flat state or bent state.

The flexible touch display panel includes a first display area and a second display area corresponding to the first back plate portion and the second back plate portion, and a virtual keyboard and a virtual touch area installed on the first display area for achieving the keyboard function and touch panel control function by displaying keyboard and touch panel.

When the laptop and tablet two-in-one computer is on the laptop mode, the bendable back panel is in bent state, and the first back plate portion is relatively mounting on a surface of the second back plate portion by the hinge further to make the flexible touch display panel be in bent state, and the first display area is relatively mounting on a same plane as the second display area

When the laptop and tablet two-in-one computer is on the laptop mode, the virtual keyboard and the virtual touch area are opened, so that the first display area has a keyboard function and a touch panel control function, and the second display area is displayed as a laptop screen.

When the laptop and tablet two-in-one computer is on the tablet mode, the bendable back panel is tablet state, the first back plate portion is situated in same plane as the second back plate through the hinged, so that the flexible touch display panel is also flat state, and the first display area is situated at a same plane as the second display area.

When the laptop and tablet two-in-one computer is the tablet mode, the virtual keyboard and the virtual touch areas are closed. The first display area and the second display area of the flexible touch display panel display a whole picture.

The outer structure of the first back plate portion and the second back plate portion is symmetrical with respect to the hinge.

The laptop and tablet two-in-one computer also includes a camera provided on the first back plate portion.

The flexible touch display panel uses a polyimide substrate as a base substrate.

The flexible touch display panel is an in-cell touch panel structure.

The present invention also provides a laptop and tablet two-in-one computer with a laptop mode and a tablet mode, and the laptop and tablet two-in-one computer includes a bendable back panel and a flexible touch display panel installed on the bendable back panel; the bendable back panel includes a first back plate portion and a second back plate portion, and the first back plate portion and the second back plate are connected by a hinge and an angle between the first back plate portion and the second back plate portion of the bendable back panel is changed by the hinge, so as to be in flat state or bent state; the flexible touch display panel includes a first display area and a second display area corresponding to the first back plate portion and the second back plate portion, and a virtual keyboard and a virtual touch area installed on the first display area for achieving the keyboard function and touch panel control function by displaying keyboard and touch panel; during the laptop mode, the bendable back panel is in bent state, and the first back plate portion is relatively mounting on a surface of the second back plate portion by the hinge further to make the flexible touch display panel be in bent state, and the first display area is relatively mounting on a same plane as the second display area; during the laptop mode, the virtual keyboard and the virtual touch area are opened, so that the first display area has a keyboard function and a touch panel control function, and the second display area is displayed as a laptop screen; during the tablet mode, the bendable back panel is flat state, the first back plate portion is situated in same plane as the second back plate through the hinged, so that the flexible touch display panel is also flat state, and the first display area is situated at a same plane as the second display area; during the tablet mode, the virtual keyboard and the virtual touch area are closed, the first display area and the second display area of the flexible touch display panel display a whole picture.

The disclosure has the advantage: a laptop and tablet two-in-one computer includes a bendable back panel and a flexible touch display panel provided on a bendable back panel; the bendable back panel includes a first back plate portion, a second back plate portion and a hinge. An angle between the first back plate and the second plate portion is changed by the hinge and the bendable back panel is flat state or bend state. The flexible touch display panel has a keyboard function and a touch panel control function by displaying a keyboard and a touch panel. The present invention eliminates the physical keyboard design of the traditional two-in-one computer by combining a flexible touch display panel with a bendable back plane. Display area and keyboard area are integrated into a flexible piece of flexible touch display panel, to solve the design cumbersome of traditional two-in-one computer connection design cumbersome, low life and other technical issues, with easy to use, superior performance and so on.

To further understand features and technical contents of the present invention, please see the following detailed description and appended drawings of the present invention, but are provided solely for reference and illustration, not intended to limit the present invention.

### BRIEF DESCRIPTION OF THE DRAWINGS

The technical aspects of the present invention and other advantageous effects will be apparent from the following detailed description of specific embodiments of the invention taken in conjunction with the accompanying drawings.

FIG. 1 is a schematic view of a front view of a laptop and tablet two-in-one computer of the present invention in a laptop mode;

FIG. 2 is a schematic view of the back of a laptop and tablet two-in-one computer of the present invention;

FIG. 3 is a schematic view showing a front view of a laptop and tablet two-in-one of the present invention in flat mode.

### DETAILED DESCRIPTION OF PREFERRED EMBODIMENTS

The technical means and the effects thereof will be further elucidated with reference to the preferred embodiments of the present invention and their accompanying drawings.

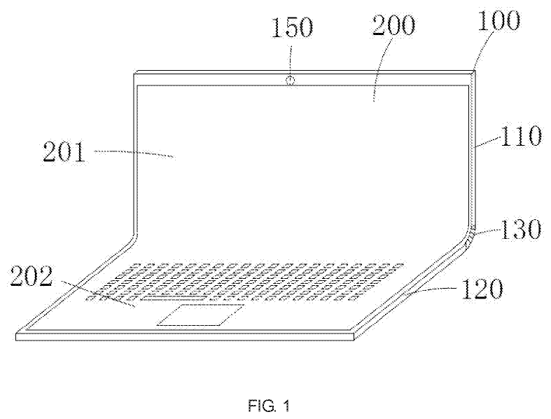

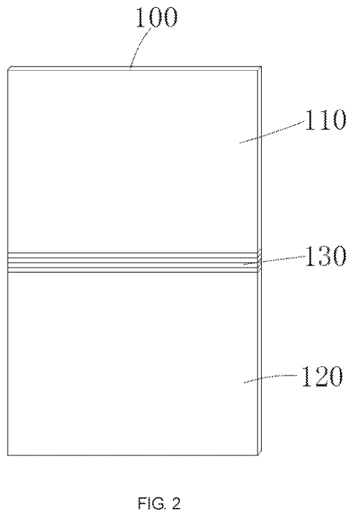

Please refer to FIG. 1 to FIG. 3, the present invention provides a laptop and tablet two-in-one computer, with a laptop mode and tablet mode, including a bendable touch back plate 100 and a flexible touch display panel 200 disposed on the touch back plate 100.

The bendable back panel 100 includes a first back plate portion 110 and a second back plate portion 120, and the first back plate portion 110 and the second back plate 120 are connected by a hinge 130 and an angle between the first back plate portion 110 and the second back plate portion 120 of the bendable back panel is changed by the hinge 130, so as to be in flat state or bent state;

The flexible touch display panel 200 includes a first display area 201 and a second display area 202 corresponding to the first back plate portion 110 and the second back plate portion 120, and a virtual keyboard and a virtual touch area installed on the first display area 201 for achieving the keyboard function and touch panel control function by displaying keyboard and touch panel.

The laptop and tablet two-in-one computer of the present invention, the flexible touch display panel 200 is combined with the bendable back panel 100, to eliminate the physical keyboard design of the conventional two-in-one computer. When in the laptop mode, the display area and the keyboard area can be achieved through a flexible touch display panel 200 with touch function to solve the problems of the cumbersome traditional two-in-one computer connection design, low life and so on, with the advantage of easy to use and superior performance.

Specifically, as shown in FIG. 1, when the laptop and tablet two-in-one computer is the laptop mode, the bendable back panel is bent state, and the first back plate portion 110 is relatively mounting on a surface of the second back plate portion 120 by the hinge further to make the flexible touch display panel 200 be in bent state, and the first display area 201 is relatively mounting on a same plane as the second display area 202.

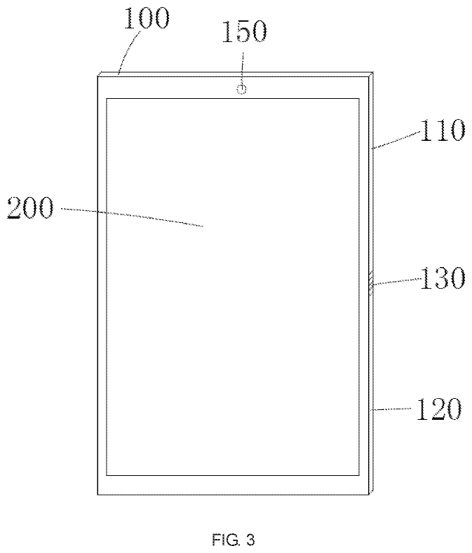

Further, when the laptop and tablet two-in-one computer is the laptop mode, the virtual keyboard and the virtual touch area are opened, so that the first display area 201 has a keyboard function and a touch panel control function, and the second display area 202 is displayed as a laptop screen. Specifically, as shown in FIG. 3, the laptop and tablet two-in-one computer is the tablet mode, the bendable back panel 100 is flat state, the first back plate portion 110 is situated in same plane as the second back plate 120 through the hinged 130, so that the flexible touch display panel 200 is also flat state, and the first display area 201 is situated at a same plane as the second display area 202.

Further, when the laptop and tablet two-in-one computer is the tablet mode, the virtual keyboard and the virtual touch area are closed, the first display area 201 and the second display area 202 of the flexible touch display panel 200 display a whole picture.

In particular, the outer structure of the first back plate portion and the second back plate portion is symmetrical with respect to the hinge.

Specifically, the laptop and tablet two-in-one computer further includes a camera 150 provided on the first back panel 110.

Specifically, the flexible touch display pane 200 is flexible with a flexible substrate as a substrate, and for example, a polyimide substrate is used as a substrate. Preferably, the flexible touch display panel 200 is an embedded touch panel structure.

In view of the above, the present invention provides a laptop and tablet two-in-one computer including a bendable back panel and a flexible touch display panel provided on the bendable back panel. The bendable back panel includes a first back plate portion, a second back plate portion and a hinge which are hinged to change the angle between the first back plate portion and the second back plate portion, and then the bendable back panel can be in flat plate state or bent state; The flexible touch display panel has a keyboard function and a touch panel control function by displaying a keyboard and a touch panel. The invention eliminates the physical keyboard design of the traditional two-in-one computer by integrating the flexible touch display panel with the bendable back panel so that the flexible touch display is achieved with a touch panel, and the invention simplifies the complicated design of the traditional two-in-one computer, and extends the service life and has the advantages of convenient use and superior performance.

As described above, it will be apparent to those skilled in the art that various other changes and modifications may be made in accordance with the technical and technical teachings of the present invention, and all such changes and modifications are intended to be within the scope of the appended claims.

What is claimed is:

1. A laptop and tablet two-in-one computer with a laptop mode and a tablet mode, comprising a bendable back panel and a flexible touch display panel installed on the bendable back panel;
the bendable back panel comprising a first back plate portion and a second back plate portion, the first back plate portion and the second back plate portion being connected by a hinge and an angle between the first back plate portion and the second back plate portion of the bendable back panel being changed by the hinge, so that the bendable back panel is in flat state or bent state;
the flexible touch display panel comprising a first display area and a second display area corresponding to the first back plate portion and the second back plate portion, and a virtual keyboard and a virtual touch area installed on the first display area for achieving the keyboard function and touch panel control function by displaying keyboard and touch panel.

2. A laptop and tablet two-in-one computer according to claim 1, wherein during the laptop mode, the bendable back panel is in bent state, and the first back plate portion relatively mounting on a surface of the second back plate portion by the hinge further to make the flexible touch display panel be in bent state, and the first display area is relatively mounting on a surface of the second back plate portion.

3. A laptop and tablet two-in-one computer according to claim 2, wherein during the laptop mode, the virtual keyboard and the virtual touch area are opened, so that the first display area has a keyboard function and a touch panel control function, and the second display area is displayed as a laptop screen.

4. A laptop and tablet two-in-one computer according to claim 1, wherein during the tablet mode, the bendable back panel is flat state, the first back plate portion is situated in same plane as the second back plate through the hinged, so that the flexible touch display panel is also flat state, and the first display area is situated at a same plane as the second display area.

5. A laptop and tablet two-in-one computer according to claim 4, wherein during the tablet mode, the virtual keyboard and the virtual touch area are closed, the first display area and the second display area of the flexible touch display panel display a whole picture.

6. A laptop and tablet two-in-one computer according to claim 1, wherein outer structure of the first back plate portion and the second back plate portion is symmetrical with respect to the hinge.

7. A laptop and tablet two-in-one computer according to claim 1, further comprising a camera provided on the first back panel.

8. A laptop and tablet two-in-one computer according to claim 1, wherein the flexible touch display panel uses a polyimide substrate as a base substrate.

9. A laptop and tablet two-in-one computer according to claim 1, wherein the flexible touch display panel is an in-cell touch panel structure.

10. A laptop and tablet two-in-one computer with a laptop mode and a tablet mode, comprising a bendable back panel and a flexible touch display panel installed on the bendable back panel;
the bendable back panel comprising a first back plate portion and a second back plate portion, the first back plate portion and the second back plate being connected by a hinge, and an angle between the first back plate portion and the second back plate portion of the bendable back panel being changed by the hinge, so as to be in flat state or bent state;
the flexible touch display panel comprises a first display area and a second display area corresponding to the first back plate portion and the second back plate portion, and a virtual keyboard and a virtual touch area installed on the first display area for achieving the keyboard function and touch panel control function by displaying keyboard and touch panel;
wherein during the laptop mode, the bendable back panel is in a bent state, and the first back plate portion is relatively mounting on a surface of the second back plate portion by the hinge further to make the flexible touch display panel be in bent state, and the first display area is relatively mounting on a same plane as the second display area;
wherein during the laptop mode, the virtual keyboard and the virtual touch area are opened, so that the first display area has a keyboard function and a touch panel control function, and the second display area is displayed as a laptop screen;
wherein during the tablet mode, the bendable back panel is flat state, the first back plate portion is situated in same plane as the second back plate through the hinged, so that the flexible touch display panel is also plate state, and the first display area is situated at a same plane as the second display area;
wherein during the tablet mode, the virtual keyboard and the virtual touch area are closed, the first display area and the second display area of the flexible touch display panel display a whole picture.

11. A laptop and tablet two-in-one computer according to claim 10 wherein outer structure of the first back plate portion and the second back plate portion is symmetrical with respect to the hinge.

12. A laptop and tablet two-in-one computer according to claim 10, further comprising a camera provided on said first back plate portion.

13. A laptop and tablet two-in-one computer according to claim 10, wherein the flexible touch display panel is a polyimide substrate as a base substrate.

14. A laptop and tablet two-in-one computer according to claim 10, wherein the flexible touch display panel is an in-cell touch panel structure.
